(19) United States
(12) Patent Application Publication
(10) Pub. No.: US 2022/0299207 A1
(43) Pub. Date: Sep. 22, 2022

(54) HYBRID GRILL SYSTEM

(71) Applicant: Logan Outdoor Products, LLC, Hyde Park, UT (US)

(72) Inventor: Brett Bennett, Mantua, UT (US)

(21) Appl. No.: 17/209,196

(22) Filed: Mar. 22, 2021

(51) Int. Cl. F24C 1/06; F24C 15/14; A47J 37/07; A23B 4/052

(52) U.S. Cl. CPC F24C 1/06; F24C 15/14; A47J 37/0713; A47J 37/0786; A23B 4/052; A23V 2002/00

(57) ABSTRACT

A hybrid grill including a cooking chamber, a solid fuel combustion unit positioned below the cooking chamber and configured to combust solid fuel, a grill housing comprising a removable front cover, and a front panel positioned underneath the removable front cover, the front panel comprising a plurality of burner apertures configured to receive a plurality of burners of a gas burner assembly.

### BACKGROUND

Pellet grills are cookers that combine elements of charcoal smokers, gas grills, and kitchen ovens. They are fueled by wood pellets and infuse food with smoky flavor associated with charcoal grills and smokers, with the convenience of gas grills, and the temperature control of traditional indoor ovens. Pellet grills can smoke as well as grill and bake using an electronic control panel to automatically feed fuel to the fire, regulate the grill's airflow, and maintain consistent cooking temperatures.

Despite increasing market differentiation in pellet grills, certain features and functionality remain elusive or suboptimal. For example, there is a notable absence of features in pellet grills that allow for direct heat operations, including optimal searing, grilling, and other direct heating methods.

Conversely, many pellet grills apply too much direct heat when used as smokers, inadvertently directing the heat produced by combustion of pellets directly onto the cooking area and overheating foods intended to be smoked slowly over a period of time.

Furthermore, maintenance and cleaning of pellet grills can be cumbersome and difficult, requiring users to disassemble the entire grill in order to clean component parts, such as air vents, drip trays, and other parts.

Consequently, there is a need for improvements in pellet grills which address the above-mentioned problems.

### BRIEF DESCRIPTION OF DRAWINGS

FIG. 1 illustrates a hybrid grill according to an exemplary embodiment.

FIG. 2 illustrates interchangeable components of the hybrid grill according to an exemplary embodiment.

FIG. 3 illustrates the internal structure of the hybrid grill according to an exemplary embodiment.

FIG. 4 illustrates the internal structure of the hybrid grill with an inserted gas burner assembly according to an exemplary embodiment.

FIG. 5 illustrates the external structure of the hybrid grill with an inserted gas burner assembly according to an exemplary embodiment.

FIGS. 6-7 illustrate front and rear views of a removable gas burner assembly according to an exemplary embodiment.

FIG. 8 illustrates further internal structure of the hybrid grill according to an exemplary embodiment.

FIG. 9 illustrates a projected smoke path within the hybrid grill according to an exemplary embodiment.

FIG. 10 illustrates a perspective view of the hybrid grill showing the drip tray according to an exemplary embodiment.

FIGS. 11A-11B illustrate removable components of the hybrid grill according to an exemplary embodiment.

### DETAILED DESCRIPTION

While a hybrid grill and its components are described herein by way of examples and embodiments, those skilled in the art recognize that the hybrid grill is not limited to the embodiments or drawings described. It should be understood that the drawings and description are not intended to be limited to the particular form disclosed. Rather, the intention is to cover all modifications, equivalents and alternatives falling within the spirit and scope of the claims. Any headings used herein are for organizational purposes only and are not meant to limit the scope of the description. As used herein, the word “can” is used in a permissive sense (i.e., meaning having the potential to) rather than the mandatory sense (i.e., meaning must). Similarly, the words “include,” “including,” and “includes” mean including, but not limited to.

As discussed above, improvements are needed in hybrid grill construction and components which allow for direct heat application when desired and also allow for indirect heating through smoking without direct heat when desired. Additionally, improvements are needed which allow for easier cleaning and maintenance of hybrid grills, without requiring disassembly of components.

Applicant has discovered a novel hybrid grill system and associated components that allow a user to convert the grill from a pellet grill having a smoker to a traditional gas burner grill or to a combination of a pellet grill and gas grill. This allows the user to configure the grill for application of direct heat to the cooking surface via the burners, to configure the grill to use pellets for smoking the food with indirect heat, or to configure the grill to use a combination of direct heat from the burners and indirect heat from a solid fuel combustion unit in the hybrid grill.

The hybrid grill further includes a heat shielding drip tray that ensures that heat and smoke produced by the solid fuel combustion unit (i.e., the smoker) does not directly heat food placed on the cooking surface. This ensures that direct heat is applied only when the user has chosen to utilize direct heat, via the gas burner assembly.

The hybrid grill further includes multiple components that enable easier access to internal components for maintenance and cleaning. This components include an access door allowing the user to access the drip tray from a front face of the housing and a rear panel within the cooking chamber that can be removed for easier cleaning.

The disclosed hybrid grill can be arranged in multiple configurations. In a first configuration, the hybrid grill includes a cooking chamber, a solid fuel combustion unit positioned below the cooking chamber and configured to combust solid fuel, a grill housing comprising a removable front cover, and a front panel positioned underneath the removable front cover, the front panel comprising a plurality of burner apertures configured to receive a plurality of burners of a gas burner assembly.

In a second configuration, the hybrid grill includes a cooking chamber, a solid fuel combustion unit positioned below the cooking chamber and configured to combust solid fuel, a front panel comprising a plurality of burner apertures and one or more panel connectors, and a removable gas burner assembly comprising a plurality of burners extending through the plurality of burner apertures and one or more burner connectors configured to removably couple with the one or more panel connectors.

The description above is presented to illustrate the primary differences between the configurations, and it is understood that both configurations will include additional components and functionality, as described throughout this application.

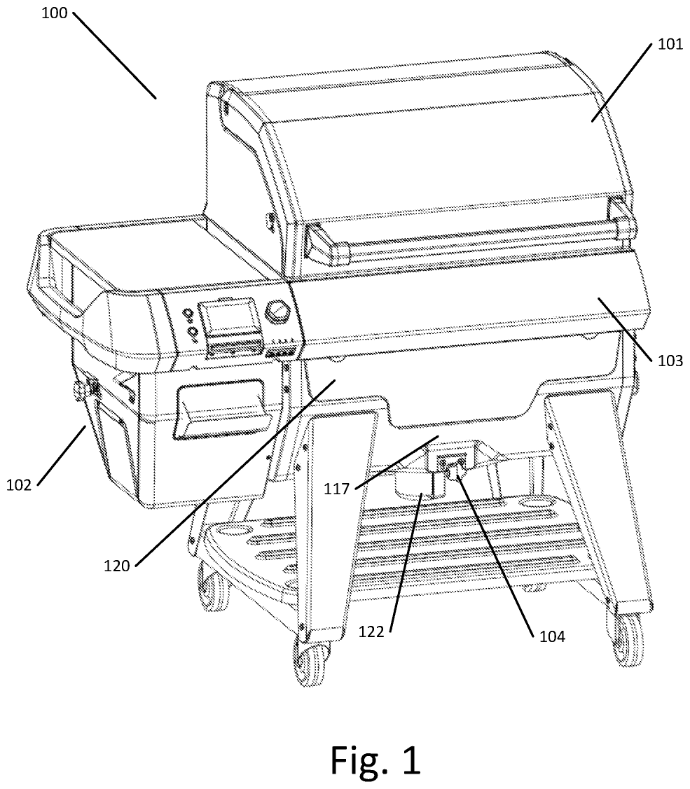

FIG. 1 illustrates a hybrid grill according to an exemplary embodiment. The hybrid grill 100 includes a housing having a retractable lid 101. Also shown in FIG. 1 is a hopper assembly 102 that receives the wooden pellets or other solid combustible fuel and feeds the solid fuel to the solid fuel combustion unit of the hybrid grill. The hopper assembly 102 can have various features as shown in FIG. 1, including work surface/side shelf for use during operation of the grill, a control panel having a visual interface, such as a touchscreen, and various controls used to input information to an onboard computing device of the hybrid grill.

The onboard computing device (not shown) can be housed within the hopper assembly 102 or elsewhere in the hybrid grill. The onboard computing device includes at least one processing unit and memory. The processing unit executes computer-executable instructions and can be a real or a virtual processor. In a multi-processing system, multiple processing units execute computer-executable instructions to increase processing power. The memory can be volatile memory (e.g., registers, cache, RAM), non-volatile memory (e.g., ROM, EEPROM, flash memory, etc.), or some combination of the two. The memory can store software implementing described techniques.

The onboard computing device can have additional features. For example, the onboard computing device includes storage, one or more input devices (such as touchscreen), one or more output devices (such as touchscreen), and one or more communication connections (e.g., wifi to communicate with a wireless network, Bluetooth for proximate device). An interconnection mechanism, such as a bus, controller, or network interconnects the components of the onboard computing device. Typically, operating system software or firmware (not shown) provides an operating environment for other software executing in the onboard computing device, and coordinates activities of the components of the onboard computing device.

The storage can be removable or non-removable, and includes magnetic disks, magnetic tapes or cassettes, USB thumb drives, CD-ROMs, CD-RWs, DVDs, or any other medium which can be used to store information and which can be accessed within the onboard computing device. The storage can store instructions for the software executing on the onboard computing device.

The input device(s) can be a touch input device such as a keyboard, mouse, pen, trackball, touch screen, or game controller, a voice input device, a scanning device, a digital camera, remote control, or another device that provides input to the onboard computing device. The output device(s) can be a display, television, monitor, printer, speaker, or another device that provides output from the onboard computing device.

The communication connection(s) enable communication over a communication medium to another computing entity, such as a router, wireless modem, mobile device, etc. The communication medium conveys information such as computer-executable instructions, audio or video information, or other data in a modulated data signal. A modulated data signal is a signal that has one or more of its characteristics set or changed in such a manner as to encode information in the signal. By way of example, and not limitation, communication media include wired or wireless techniques implemented with an electrical, optical, RF, infrared, acoustic, or other carrier.

The onboard computing device can include software with functionality for controlling or programming the pellet hopper, the solid fuel combustion unit functionality, the gas burners, and/or any other functionality of the hybrid grill. For example, a user can use the onboard computing device and its software to program when to activate or deactivate the smoker functionality, when to activate or deactivate gas burners, set a schedule for the gas burner or smoker or to perform other functionality.

Returning to FIG. 1, an ash cleanout mechanism 104 is disposed under the solid fuel combustion unit (117—positioned within the grill housing). The ash cleanout mechanism 104 includes an ash cleanout door with opposed longitudinal sides, and the bottom of the solid fuel combustion chamber includes supports that engage the longitudinal sides and enable the ash cleanout door to translate longitudinally and/or linearly in slidable fashion. The ash cleanout door is dimensioned to span the width of opening connecting it with the solid fuel combustion unit 117 so that the opening is entirely occluded and blocked.

The ash cleanout door is configured to move between a first position in which the second end opening of the ash cleanout mechanism 104 is closed to retain ash within the solid fuel combustion unit and a second position wherein the second end opening is open to release the retained ash from the solid fuel combustion unit 117 to a separate compartment, such as container 122.

A pull link is connected to the ash cleanout door and disposed to extend towards the front of the hybrid grill. The link protrudes from the front of the grill assembly—thereby operable by a user from a position external to the cooking chamber—and terminates in a handle or knob. The knob enables a user to slide the ash cleanout door out of its blocking position in the second end opening and between first and second positions. When the ash cleanout door is pulled free of the second end opening the ash that has accumulated in the solid fuel combustion unit is free to fall through the opening to be collected in a disposal container 122.

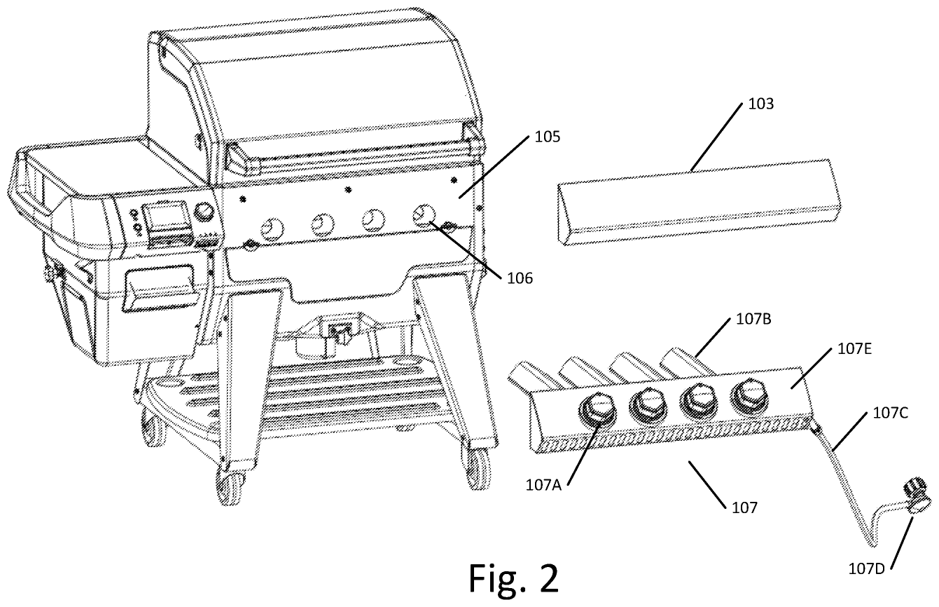

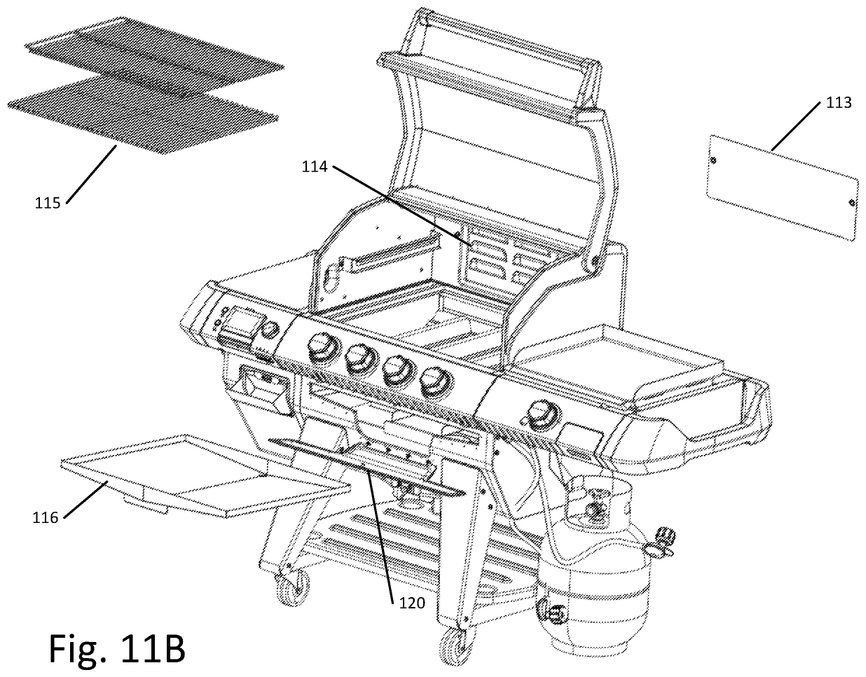

FIG. 1 also illustrates several adjustable and removable components of the hybrid grill 100. A removable front cover 103 can be removed by a user in order to insert a gas burner assembly, as discussed below with respect to FIGS. 2-5. Additionally, as explained with respect to FIGS. 11A-11B, access door 120 forms part of the part of a front face of the grill housing, and opens to allow a user to access a drip tray and heat deflector disposed within the body of the hybrid grill.

FIG. 2 illustrates interchangeable components of the hybrid grill according to an exemplary embodiment. As shown in FIG. 2, the removable front cover 103 can be removed from the front of the hybrid grill to reveal a front panel 105 that is positioned underneath the removable front cover 103. The front panel 103 includes a plurality of burner apertures, such as aperture 106. The plurality of burner apertures are configured to receive a plurality of burners of a gas burner assembly 107, described below. Each of the apertures of the plurality of burner apertures is configured to receive a corresponding burner of the gas burner assembly 107. The burners pass through the burner apertures into the body of the hybrid grill and are held in place there using support structures within the hybrid grill and/or connectors that connect the gas burner assembly 107 to the hybrid grill. Optionally, the burner apertures can initially include removable cutouts configured to fill the apertures and configured to be removed by user. A user can then punch out or otherwise remove the cutout/fillings to expose the apertures.

The gas burner assembly 107 includes a plurality of burners, such as burner 107B, and a gas burner front cover 107E that replaces removable front cover 103. The gas burner assembly 107 also includes a plurality of control knobs positioned on the gas burner front cover 107E, such as control knob 107A, that are coupled to the plurality of burners. The gas burner assembly 107 further includes a gas intake tube 107C coupled to the gas burner front cover 107E. The gas intake tube 107C includes a tank connector 107D configured to couple the gas intake 107C tube to a gas tank, such as a propane tank, and thereby provide gas to the plurality of burners. The plurality of control knobs can be used to adjust the flow of gas to each of the plurality of burners. Additionally, the gas burner assembly 107 can include additional components, such as an ignite button or switch configured to initially spark the burners.

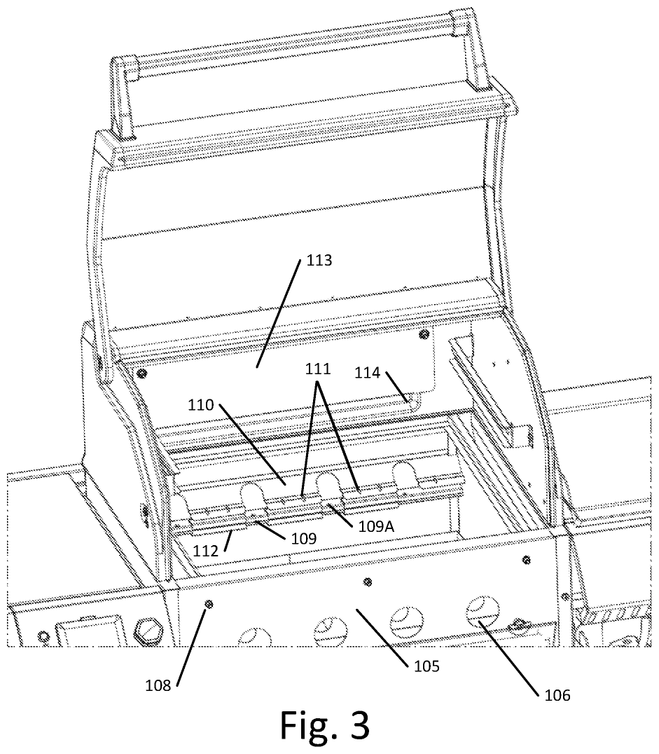

FIG. 3 illustrates the internal structure and additional details of the hybrid grill according to an exemplary embodiment. As shown in FIG. 3, front panel 105 includes one or more panel connectors, such as panel connector 108, that are configured to removably couple with one or more corresponding burner connectors on the gas burner assembly. The panel connectors and burner connectors can be configured to mate or fit within each other and can take a variety of forms, such as snap-fit structure, screws with corresponding threads, adhesive based connectors, etc.

FIG. 3 additionally illustrates an interior support structure 109 disposed on a back wall of the hybrid grill. The interior support structure 109 is configured to at least partially support the plurality of burners. As shown in FIG. 3, the interior support structure 109 can be, for example, an interior shelf disposed on the back wall of the hybrid grill. The interior support structure can also take a number of other forms, such as a railing, a plurality of posts or pegs, a ledge, a vertically oriented support structure, or other forms.

The interior support structure 109 is positioned below the cooking chamber and above the solid fuel combustion unit. This allows the plurality of burners of the gas burner assembly to rest on the interior support structure just below the cooking chamber in order to provide direct heat to the cooking surface, such as a grill grate.

The interior support structure 109 additionally includes a plurality of indentations, such as indentation 109A, configured to receive a distal end of each of the plurality of burners. Each indentation can be an opening, slit, or other aperture configured to receive a portion of a corresponding burner in the gas burner assembly.

Each burner in the plurality of burners of the gas burner assembly includes a burner tube that routes flammable gases through the tube and also includes a burner shield disposed above the burner tube that is configured to partially block, control, and direct the flames produced by each of the burner tubes. Each of indentations, such as indentation 109A, can be configured to receive a distal end of a corresponding burner tube.

Additionally, the interior of the hybrid grill can include additional structures to hold the gas burner assembly and its components in place. As shown in FIG. 3, a shield receptacle surface 110 is disposed above and adjacent to the interior support structure 109 on the back wall of the hybrid grill and is used to hold the burner shields of the plurality of burners in place. The shield receptacle surface 110 can take any suitable form and can be part of the interior support structure 109. The shield receptacle surface 110 can be, for example, a flap of rigid and/or metallic material, and/or a shelf or ledge, a protrusion, peg, or other element projecting from an inner wall of hybrid grill or from the interior support structure 109.

The shield receptacle surface 110 that is disposed above the interior support structure on the back wall of the hybrid grill includes a plurality of pairs of shield apertures, such as the pair of shield apertures 111. The plurality of pairs shield apertures correspond to the plurality of burners of the gas burner assembly. Each pair of shield apertures is configured to receive two corners of a corresponding burner shield, thereby holding the burner shield in place.

Optionally, a sleeve or other outer structure 112 can be placed on the interior support structure 109 and can provide an interface between the interior support structure 109 and the shield receptacle surface 110.

FIG. 3 illustrates additional components of the hybrid grill, include an interior rear panel 113 positioned on a back wall of the cooking chamber, the interior rear panel being removably coupled to the back wall of the grill housing. Additionally, one or more air vents 114 are disposed on a back wall of the grill housing to vent excess smoke from the cooking chamber and increase air circulation within the cooking chamber.

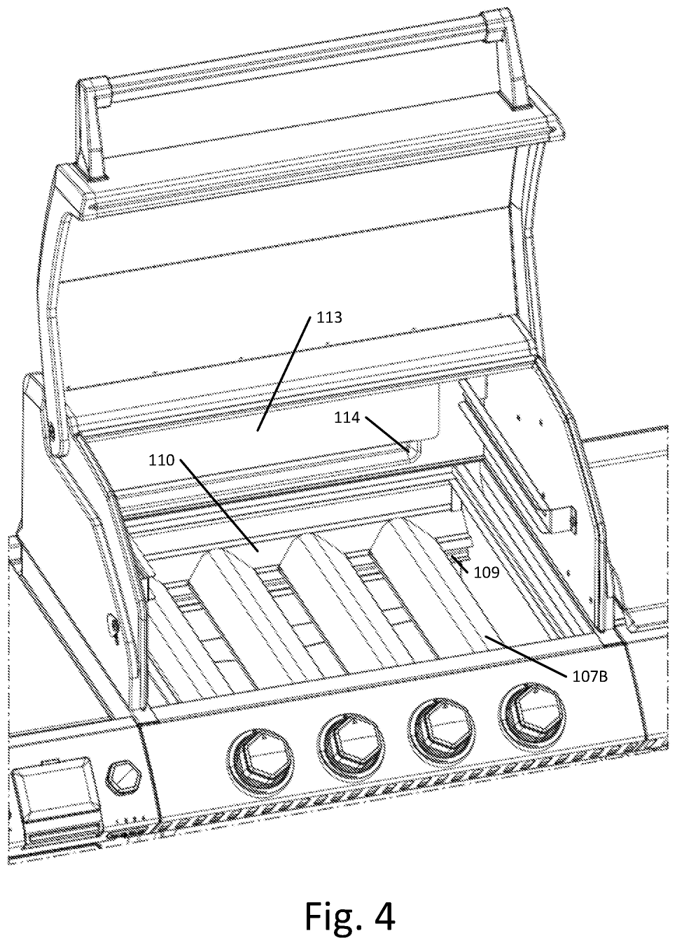

FIG. 4 illustrates the internal structure of the hybrid grill with an inserted gas burner assembly according to an exemplary embodiment. As shown in FIG. 4, the plurality of burners, including burner 107B, are supported against the back wall of the grill by the interior support structure 109. Additionally, the burner shields of each of the burners are further supported by the shield receptacle surface 110.

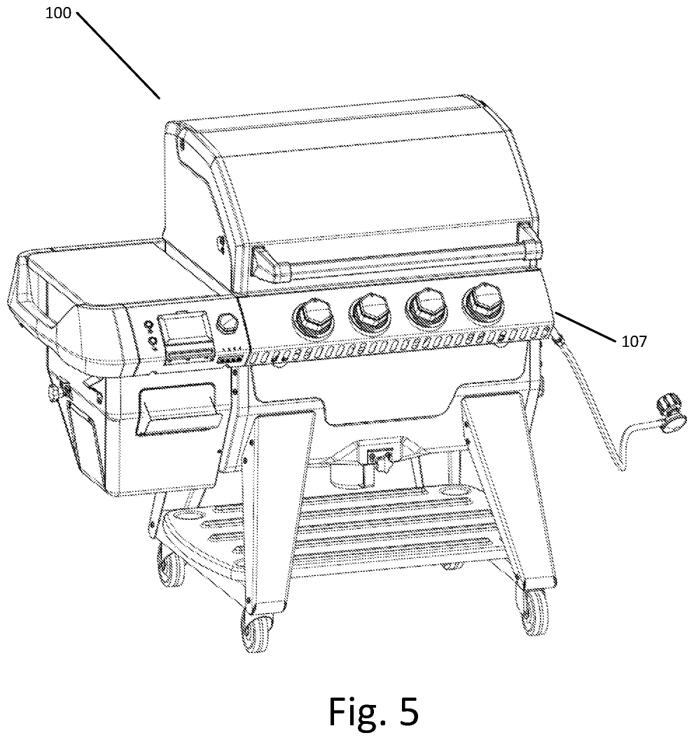

FIG. 5 illustrates the the hybrid grill with an inserted gas burner assembly according to an exemplary embodiment. As shown in FIG. 5, the gas burner assembly 107 fits within the housing of the grill 100 and takes the place of the removable front cover. One the gas burner assembly is connected to a propane tank or other gas source, a user can begin utilizing the gas burner in addition to or instead of the smoker functionality from the solid fuel combustion unit.

The assembled hybrid grill shown in FIG. 5 includes a cooking chamber, a solid fuel combustion unit positioned below the cooking chamber and configured to combust solid fuel, a front panel comprising a plurality of burner apertures and one or more panel connectors, and a gas burner assembly comprising a plurality of burners extending through the plurality of burner apertures and one or more burner connectors configured to removably couple with the one or more panel connectors.

As will be described in greater detail below, the hybrid grill shown in FIG. 5 also includes a removable drip tray disposed above the solid fuel combustion unit and below the cooking chamber and the gas burner assembly, the drip tray being configured to prevent smoke from the solid fuel combustion unit from rising directly into the cooking chamber.

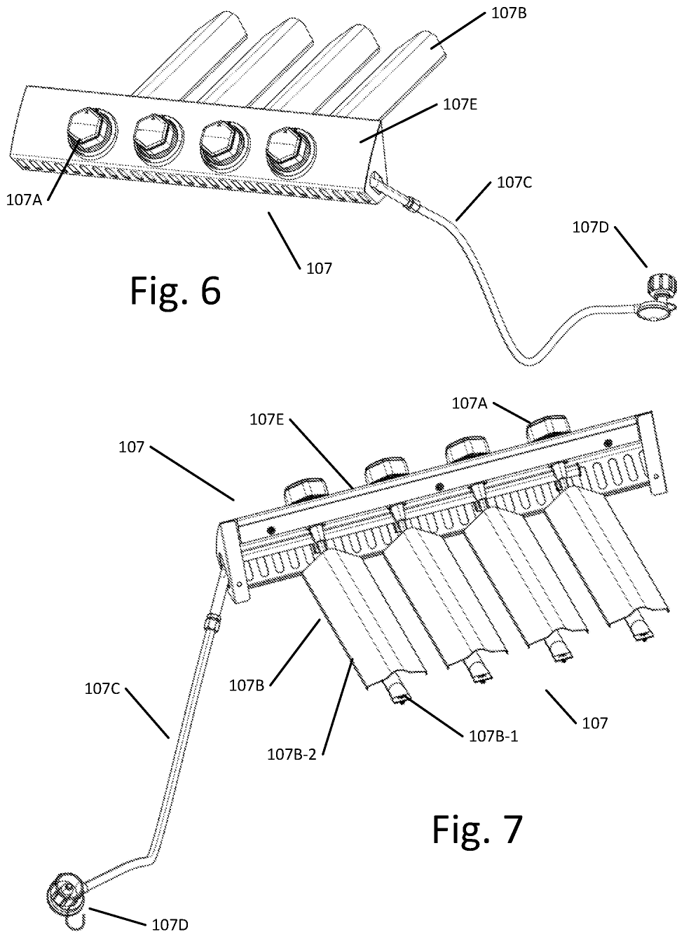

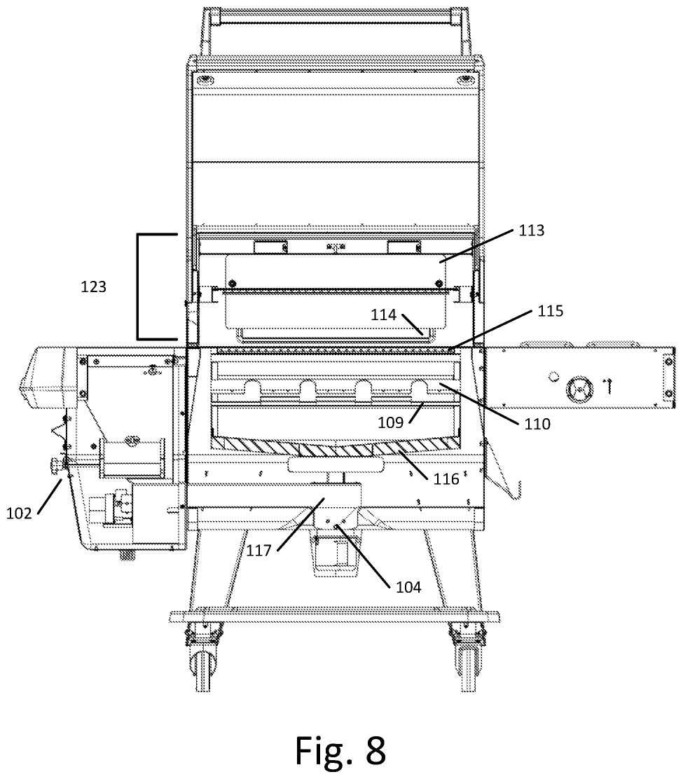

FIGS. 6-7 illustrate front and rear views of a removable gas burner assembly according to an exemplary embodiment. Gas burner assembly 107 includes a plurality of burners, such as burner 107B, a gas burner front cover 107E, a plurality of control knobs positioned on the gas burner front cover 107E and coupled to the plurality of burners, such as control knob 107A, and a gas intake tube 107C coupled to the gas burner front cover, the gas intake tube 107C comprising a tank connector 107D configured to couple the gas intake tube to a gas tank. FIG. 7 illustrates additional components of the burners in the gas burner assembly. 10. Specifically, each burner in the plurality of burners includes a burner tube, such as burner tube 107B-1, and a burner shield disposed above the burner tube, such as burner shield 107B-2.

Of course, the specific features of the gas burner assembly shown in FIGS. 6-7 and other figures are provided for illustration only, and the gas burner assembly can take a number of forms. For example, the quantity of gas burners can be greater than or less than four burners, the burner shield can have different dimensions, and/or the control knobs can have a different appearance.

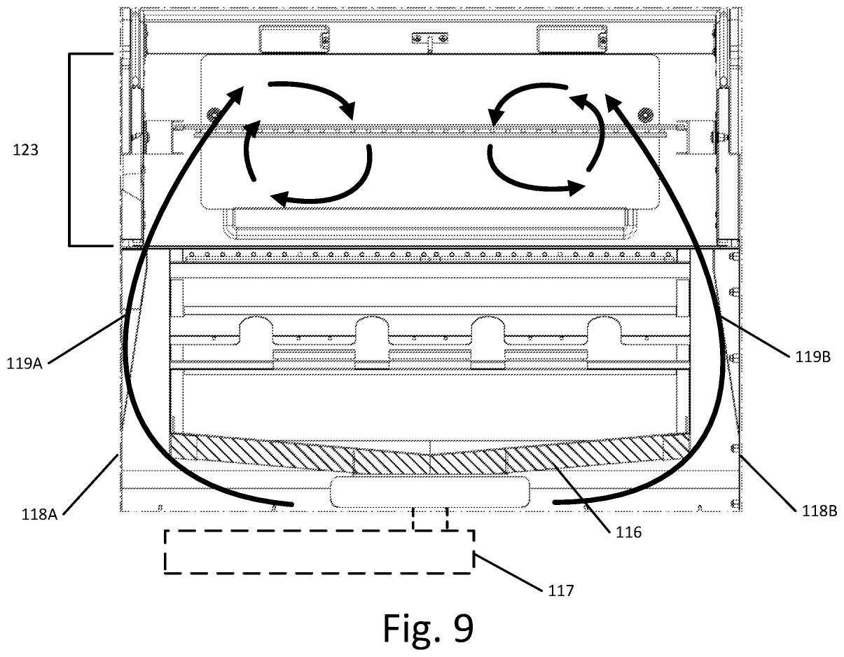

FIG. 8 illustrates further internal structure of the hybrid grill according to an exemplary embodiment. As shown in FIG. 8, the cooking chamber 123 is separated from the lower part of the grill by a grate or other cooking surface 115. The hopper 102 feeds solid fuel, such as pellets, to the solid fuel combustion unit 117. As discussed previously, the ash from combustion is routed to ash cleanout mechanism 104.

FIG. 8 additionally illustrates a drip tray 116 that is disposed above the solid fuel combustion unit 117 and below the cooking chamber 123. For purposes of clarity, the drip tray, which functions as a heat shield, 116 is shown with diagonal shading lines. As shown in the figure, the drip tray 116 is disposed above the solid fuel combustion unit 117 in order prevent smoke and direct heat from the solid fuel combustion unit 117 from directly rising to the cooking surface 115 and the cooking chamber 123.

The drip tray 116 is dimensioned and positioned to route smoke and hot air produced by the solid fuel combustion unit 117 to the sides of the grill. As explained in greater detail below, the drip tray is specifically configured, through its size, dimensions, and/or position, to prevent smoke from the solid fuel combustion unit 117 from rising directly into the cooking chamber 123.

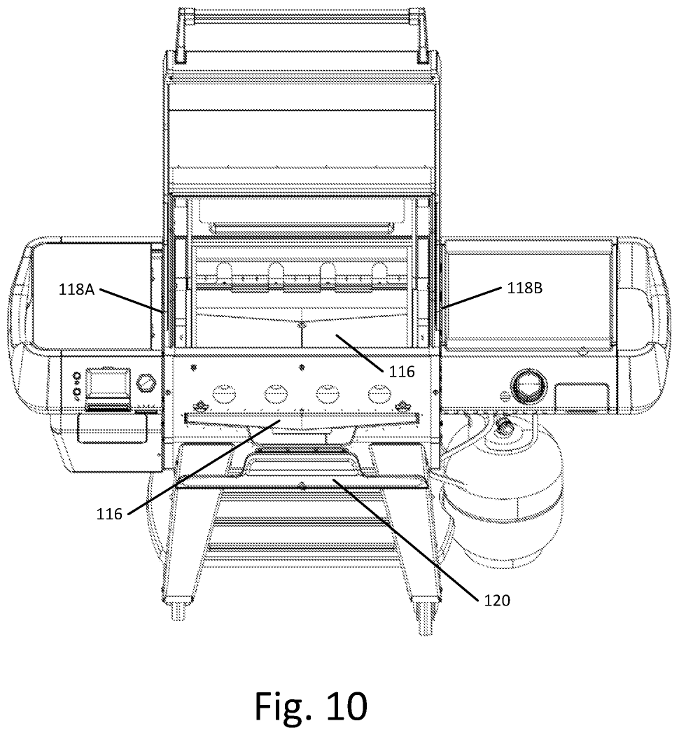

FIG. 9 illustrates a projected smoke path within the hybrid grill according to an exemplary embodiment. As shown in FIG. 9, the drip tray 116 is configured to route smoke from the solid fuel combustion unit 117 to opposite sides of the hybrid grill adjacent to sidewalls of the hybrid grill prior to the smoke rising into the cooking chamber 123. The projected path of the smoke from the solid fuel combustion unit 117 is shown with arrow 119A, adjacent to sidewall 118A, and arrow 119B, adjacent to sidewall 118B.

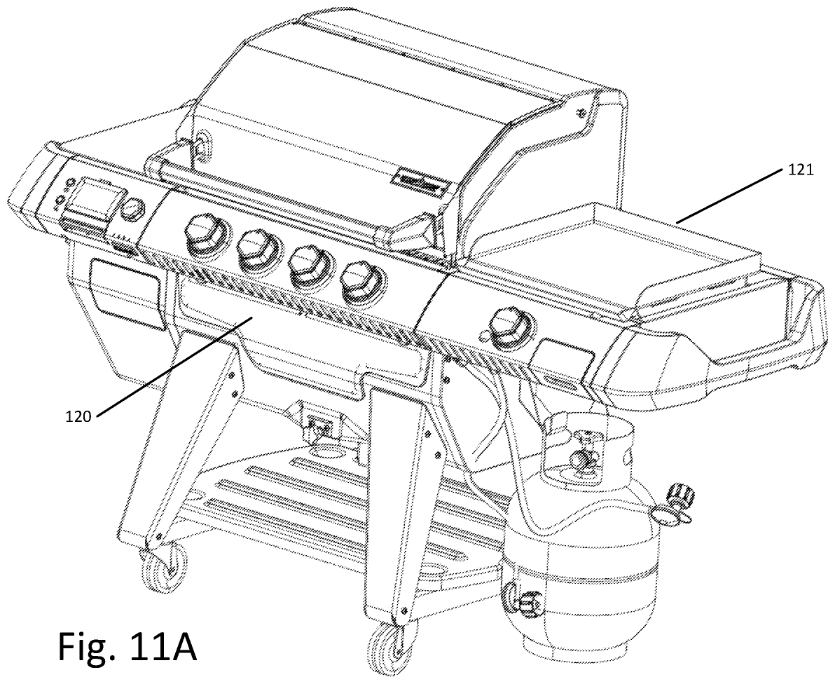

FIG. 10 illustrates a perspective view of the hybrid grill showing the drip tray according to an exemplary embodiment. As explained above, the drip tray 116 functions as a heat shield to funnel smoke to a pair of channels adjacent to the sidewalls, 118A and 118B, of the grill to thereby prevent direct heat or smoke produced by the solid fuel combustion unit from reaching the cooking chamber. The drip tray 116 can be dimensioned within the hybrid grill such that it is flush with (or proximate to) a front wall and a back wall of the hybrid grill and configured to allow airflow only adjacent to sidewalls, 118A and 118B, of the hybrid grill. FIG. 10 also shows access door 120 in an open position. As indicated in the figure, the drip tray 116 is accessible from the front of the grill through the access door 120. As explained below, this allows users to easily remove and clean the drip tray/heat shield.

FIGS. 11A-11B illustrate removable components of the hybrid grill according to an exemplary embodiment. As shown in FIG. 11A, the hybrid grill can include an optional right side shelf 121 which can be removably attached to the body of the hybrid grill Right side shelf 121 include a cooking grate and/or a griddle and can include a burner that is also coupled to a gas tank, such as the propane tank shown in the figure.

FIG. 11A also illustrates access door 120 used to access the drip tray. The access door 120 forms part of a front face of the grill housing. The access door 120 is configured to transition from a closed position, in which the drip tray is inaccessible from the front face, to an open position, in which the drip tray is removable from the front face. The access door 120 can have a hinge or other mechanism that allows the access door to swing open. Alternatively, the access door 120 can be a detachable or removable door which can be removed from the hybrid grill to transition the access door to the open position and reattached to transition the access door to the closed position.

As shown in FIG. 11A, the access door 120 is in the closed position. FIG. 11B illustrates the access door 120 in the open position. Although the access door 120 in FIG. 11B is shown swinging open on a hinge adjacent to the bottom edge, the access door 120 can also be configured to have a hinge adjacent to left edge, right edge, or top edge of the access door 120 and to swing open in other directions. Additionally, as discussed above, the access door 120 can be detachably coupled to the hybrid grill.

FIG. 11B illustrates the removed drip tray/heat shield component 116. The drip tray is configured to slide out of the access door 120 when the access door 120 is in the open position. Additionally, as shown in FIG. 11B, the interior rear panel 113 can also be removed from the back wall of the cooking chamber of the hybrid grill. As shown in earlier figures, such as FIG. 8, the interior rear panel 113 is configured to be positioned on a back wall of the cooking chamber 123 when the hybrid grill is in operation. The interior rear panel 113 is removably coupled to the back wall of the grill housing, such as with screws, a snap-fit mechanism, or other components or connectors. Returning to FIG. 11B, the removal of the interior rear panel 113 can make it easier for users to clean the interior rear panel 113, as well as one or more air vents 114 that are disposed on a back wall of the grill housing. Additionally, the cooking surface/grill grates 115 can also be removed from the hybrid grill for cleaning purposes.

As shown in the figures and described in this specification, inventors have invented a novel hybrid grill that converts from a pure pellet grill/smoker to a gas burning grill or to a combination pellet/gas grill and includes a heat shielding drip tray that funnels smoke to the sides of the grill prior to rising into the cooking chamber. The novel hybrid grill thereby allows for direct heat application when desired and indirect heating through smoking without direct heat when desired. Additionally, the novel hybrid grill disclosed herein includes several removable or accessible components and access doors that transition between closed/attached and open/removed positions to thereby allow easy access to internal components, such as the drip tray. These features allow for easier cleaning and maintenance of hybrid grills, without requiring disassembly of components.

Having described and illustrated the principles of our invention with reference to the described embodiment, it will be recognized that the described embodiment can be modified in arrangement and detail without departing from such principles. Elements of the described embodiment shown in software can be implemented in hardware and vice versa.

In view of the many possible embodiments to which the principles of our invention can be applied, we claim as our invention all such embodiments as can come within the scope and spirit of the following claims and equivalents thereto.

1. A hybrid grill, comprising:
a cooking chamber;
a solid fuel combustion unit positioned below the cooking chamber and configured to combust solid fuel;
a grill housing comprising a removable front cover; and
a front panel positioned underneath the removable front cover, the front panel comprising a plurality of burner apertures configured to receive a plurality of burners of a gas burner assembly.

2. The hybrid grill of claim 1, the front panel comprising one or more panel connectors configured to removably couple with one or more burner connectors on the gas burner assembly.

3. The hybrid grill of claim 1, further comprising an interior support structure disposed on a back wall of the hybrid grill, the interior support structure being configured to at least partially support the plurality of burners.

4. The hybrid grill of claim 3, wherein interior support structure comprises an interior shelf disposed on the back wall of the hybrid grill.

5. The hybrid grill of claim 3, wherein the interior support structure is positioned below the cooking chamber and above the solid fuel combustion unit.

6. The hybrid grill of claim 3, wherein the interior support structure comprises a plurality of indentations configured to receive a distal end of each of the plurality of burners.

7. The hybrid grill of claim 6, wherein each burner in the plurality of burners comprises a burner tube and wherein each indentation in the plurality of indentations is configured to receive a distal end of a corresponding burner tube.

8. The hybrid grill of claim 3, wherein each burner in the plurality of burners comprises a burner shield and further comprising:
a shield receptacle surface disposed above the interior support structure on the back wall of the hybrid grill, the shield receptacle surface comprising a plurality of pairs of shield apertures corresponding to the plurality of burners, wherein each pair of shield apertures is configured to receive two corners of a corresponding burner shield.

9. The hybrid grill of claim 1, wherein the gas burner assembly comprises:
the plurality of burners;
a gas burner front cover;
a plurality of control knobs positioned on the gas burner front cover and coupled to the plurality of burners; and
a gas intake tube coupled to the gas burner front cover, the gas intake tube comprising a tank connector configured to couple the gas intake tube to a gas tank.

10. The hybrid grill of claim 9, wherein each burner in the plurality of burners comprises a burner tube and a burner shield disposed above the burner tube.

11. The hybrid grill of claim 1, further comprising:
a drip tray disposed above the solid fuel combustion unit and below the cooking chamber, the drip tray being configured to prevent smoke from the solid fuel combustion unit from rising directly into the cooking chamber.

12. The hybrid grill of claim 11, wherein the drip tray is configured to route smoke from the solid fuel combustion unit to opposite sides of the hybrid grill adjacent to sidewalls of the hybrid grill prior to the smoke rising into the cooking chamber.

13. The hybrid grill of claim 11, wherein the drip tray is flush with a front wall and a back wall of the hybrid grill and configured to allow airflow only adjacent to sidewalls of the hybrid grill.

14. The hybrid grill of claim 11, further comprising an access door forming part of a front face of the grill housing, the access door being configured to transition from a closed position, in which the drip tray is inaccessible from the front face, to an open position, in which the drip tray is removable from the front face.

15. The hybrid grill of claim 14, wherein the drip tray is configured to slide out of the access door when the access door is in the open position.

16. The hybrid grill of claim 1, further comprising one or more air vents disposed on a back wall of the grill housing.

17. The hybrid grill of claim 1, further comprising an interior rear panel positioned on a back wall of the cooking chamber, the interior rear panel being removably coupled to the back wall of the grill housing.

18. A hybrid grill, comprising:
a cooking chamber;
a solid fuel combustion unit positioned below the cooking chamber and configured to combust solid fuel;
a front panel comprising a plurality of burner apertures and one or more panel connectors; and
a gas burner assembly comprising a plurality of burners extending through the plurality of burner apertures and one or more burner connectors configured to removably couple with the one or more panel connectors.

19. The hybrid grill of claim 18, further comprising a drip tray disposed above the solid fuel combustion unit and below the cooking chamber and the gas burner assembly, the drip tray being configured to prevent smoke from the solid fuel combustion unit from rising directly into the cooking chamber.

20. The hybrid grill of claim 19, further comprising an access door forming part of a front face of the grill housing, the access door being configured to transition from a closed position, in which the drip tray is inaccessible from the front face, to an open position, in which the drip tray is removable from the front face.
